(19) United States
(12) Patent Application Publication
(10) Pub. No.: US 2025/0215290 A1
(43) Pub. Date: Jul. 3, 2025

(54) POLYURETHANE ADHESIVE COMPOSITIONS AND USE OF THE SAME

(71) Applicant: Dow Global Technologies LLC, Midland, MI (US)

(72) Inventors: Yanbin Fan, Shanghai (CN); Qingwei Meng, Shanghai (CN); Qihang Qiu, Shanghai (CN); Jing Liu, Shanghai (CN)

(21) Appl. No.: 18/850,245

(22) PCT Filed: Mar. 25, 2022
(86) PCT No.: PCT/CN2022/082950

§ 371 Date: Sep. 24, 2024

(51) Int. Cl. C09J 175/14; C08G 18/12; C08G 18/32; C08G 18/48; C08G 18/66; C08G 18/67; C09J 5/00

(52) U.S. Cl. CPC C09J 175/14; C08G 18/12; C08G 18/3206; C08G 18/4829; C08G 18/6674; C08G 18/675; C09J 5/00

(57) ABSTRACT

Provided is a polyurethane adhesive composition, comprising, (a) a polyol component, comprising a phosphate modified polyol and a vegetable oil modified polyol, and (b) an isocyanate component, comprising an NCO-terminated polyurethane prepolymer that is the reaction product of (i) a polyester polyol based on a dimeric acid and an aromatic dicarboxylic acid, and (ii) an isocyanate monomer.

### FIELD OF THE DISCLOSURE

The present disclosure relates to an adhesive composition, more particularly to a two-component polyurethane adhesive composition.

### BACKGROUND

Mass production of battery packs in an economic way has gained revolutionarily developed during the past years and leaped forward the adoption of electrical vehicles (EV) all over the globe. Due to low cost, low volatility, high body strength and toughness, polyurethane adhesives have become popular solutions to battery pack assembly, where battery cells are bonded onto cooling plates by the polyurethane adhesives.

The bonding substrates for battery pack assembly mainly include aluminum alloy, PET film, polycarbonate etc., where Al alloy-Al alloy bonding is the most significant one. However, the effective bonding between Al alloys is difficult due to high surface energy and absence of organic chemical groups on the Al alloy surfaces. On the other hand, moisture resistance of the polyurethane components (including polyol and isocyanate parts) is another important industrial need. This is because that both the polyol and isocyanate parts can easily absorb moisture. For the isocyanate part, the absorbed moisture leads to reduction of NCO contents and formation of solid skins starting from the top of the components. As a result, the reduced NCO contents will cause incorrect feed ratios between the reaction groups and the thick skins usually block the storage tanks and/or dispensing tunnels, leading to product defects and production breaks, respectively. For the polyol part, the absorbed moisture can bring significant bubbles to the cured adhesives after mixing and dispensing the polyol part with isocyanate part.

Therefore, there is still a need for a polyurethane adhesive composition that provides good moisture resistance, adhesion strength, and cost efficiency.

### SUMMARY OF THE DISCLOSURE

In an aspect, the present disclosure provides a polyurethane adhesive composition, comprising,
(a) a polyol component, comprising a phosphate modified polyol and a vegetable oil modified polyol, and
(b) an isocyanate component, comprising an NCO-terminated polyurethane prepolymer that is the reaction product of (i) a polyester polyol based on a dimeric acid and an aromatic dicarboxylic acid, and (ii) an isocyanate monomer.

In a further aspect, the present disclosure provides an isocyanate agent for use in a polyurethane adhesive composition, comprising an NCO-terminated polyurethane prepolymer that is the reaction product of (i) a polyester polyol based on a dimeric acid and an aromatic dicarboxylic acid, and (ii) an isocyanate monomer.

In a further aspect, the present disclosure provides a method of using the polyurethane adhesive composition described herein, comprising:
(a) providing the polyurethane adhesive composition as described herein, wherein the polyol component and the isocyanate component are provided, separated from each other;
(b) bringing the polyol component and the isocyanate component into contact, to form a curable mixture;
(c) applying the curable mixture to a first substrate to which at least a second substrate is to be bonded;
(d) bringing the second substrate into contact with the first substrate so that at least a portion of the curable mixture is sandwiched between the first substrate and the second substrate; and
(e) curing the curable mixture or allowing it to cure.

In a further aspect, the present disclosure provides use of the polyurethane adhesive composition described herein in a battery pack.

It is to be understood that both the foregoing general description and the following detailed description are exemplary and explanatory only and are not restrictive of the invention, as claimed.

### DETAILED DESCRIPTION OF THE DISCLOSURE

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated.

As disclosed herein, all percentages mentioned herein are by weight, and temperatures in ° C., unless specified otherwise.

### A. Polyurethane Adhesive Composition

In an aspect, the present disclosure provides a polyurethane adhesive composition, comprising,
(a) a polyol component, comprising at least one phosphate modified polyol and at least one vegetable oil modified polyol, and
(b) an isocyanate component, comprising an NCO-terminated polyurethane prepolymer that is the reaction product of (i) a polyester polyol based on a dimeric acid and an aromatic dicarboxylic acid, and (ii) an isocyanate monomer.

The polyurethane adhesive composition described herein is a two-component composition. As used herein, the term “two-component” means that the composition is provided in parts separated from each other before making them react. For example, the polyol component and the isocyanate component of the composition can be prepared, stored, transported and served separately, and combined shortly or immediately, for example, in a mixer, to form a reactive mixture. It is contemplated that when these two components are brought into contact, a curing reaction begins in which the polyol groups react with the isocyanate groups to form urethane links. The reactive polyurethane composition formed by bringing the two components into contact can be referred to as “reactive liquid intermediates” or a “reactive mixture.”

The mixing ratios between the polyol component and the isocyanate component are not strictly limited. In some exemplary embodiments, the isocyanate component and the polyol component can have an NCO/OH molar ratio of from 0.9:1 to 1.95:1, for example, from 1:1 to 1.9:1, or from 1.05:1 to 1.85:1. In some exemplary embodiments, the isocyanate component and the polyol component can be combined at a volume ratio of about 1:1, for example, from 1:1.2 to 1:0.8, from 1:1.1 to 1:0.9, or from 1:1.05 to 1:0.95.

Generally, the polyurethane adhesive composition as described is solvent-free.

### (A) Polyol Component

The polyol component of the polyurethane adhesive composition comprises at least one phosphate modified polyol and at least one vegetable oil modified polyol.

In addition to the phosphate modified polyol and vegetable oil modified polyol as described, the polyol component can comprise one or more additional polyols.

The polyol component can optionally comprise one or more additives, for example, plasticizers, flame retardants, adhesion promoters, rheology modifiers, fillers, or any combination thereof.

Generally, the polyol component described herein is solvent-free. As used herein, the term “solvent-free” means that the adhesive composition can be applied (for example, up to one hundred percent solids) without either organic solvent or an aqueous carrier. In some embodiments of the present disclosure, the adhesive composition comprises less than 4% by weight, less than 3% by weight, less than 2% by weight, less than 1% by weight, less than 0.5% by weight, less than 0.2% by weight, less than 0.1% by weight, less than 100 ppm by weight, less than 50 ppm by weight, less than 10 ppm by weight, less than 1 ppm by weight of any organic or inorganic solvent or water, or is free of any organic or inorganic solvent or water.

### Phosphate Modified Polyol

At least one phosphate modified polyol (for example, a phosphate ester polyol) is comprised in the polyol component.

Generally, the at least one phosphate modified polyol can function as an adhesion promoter in the polyol component.

“A phosphate modified polyol” as used herein refers to a compound that has two or more hydroxyl groups and one or more structure (I):

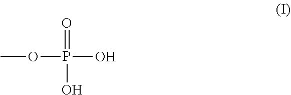

Included in structure I are structures in which one or more of the acidic hydrogen atoms has been abstracted. The acid hydrogen atoms are the hydrogen atoms attached to oxygen atoms that are attached to a phosphorous atom. When one or more acidic hydrogens have been abstracted, the phosphate group is an anion.

In some embodiments, the polyol component can comprise one or more phosphate modified polyols represented by structure (II):

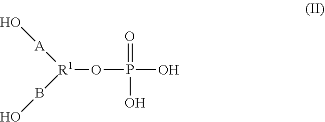

where R¹ is a trivalent group, for example, a C₁-C₁₆ (e.g., C₁-C₁₀, C₁-C₈, or C₁-C₆) trivalent group (e.g., a C₁-C₁₆ alkylidyne); A and B are each independently a direct bond or a divalent group, for example, a C₁-C₁₆ (e.g., C₁-C₁₀, C₁-C₈, or C₁-C₆) divalent group (e.g., a C₁-C₁₆ alkylene), with the proviso that A and B are not both a direct bond. In addition to the pendant groups shown in structure (II), R¹, A and B each independently may or may not have one or more additional pendant —OH groups, and R¹, A and B each independently may or may not have one or more additional pendant groups of structure (I). Any two or more of the —OH groups and the group(s) of structure (I) may or may not be attached to the same atom of R¹, A or B. Preferably, each-OH group and each group of structure (I) is attached to a separate atom of R¹, A and B. In some embodiments, the phosphate modified polyol is a polyether based polyol. In some embodiments, the phosphate modified polyol is a polyether based polyurethane polyol.

The phosphate ester polyol can be made from a tri-functional propylene glycol, a polyphosphoric acid, and a polyisocyanate. Commercially available examples of the tri-functional propylene glycol suitable for use according to this disclosure include products sold under the trade names VORANOL™ CP-450, VORANOL™ CP-260, VORANOL™ CP-755, and VORANOL™ CP-1055, each available from The Dow Chemical Company. In some embodiments, the phosphate ester polyol has a phosphoric acid content of less than 4 weight percent based on the weight of the phosphate ester polyol, or a phosphoric acid content of from 0 to 3 weight percent based on the weight of the phosphate ester polyol, or a phosphoric acid content of from 1.5 to 2.5 weight percent based on the weight of the phosphate ester polyol. In some embodiments, the phosphate ester polyol has a viscosity less than 40,000 cps at 25° C., or less than 30,000 cps at 25° C., as measured by the method of ASTM D2196. In some embodiments, the phosphate ester polyol has a hydroxyl equivalent weight less than 330 g/mol. In some embodiments, the phosphate ester polyol has from 0 to 100 weight percent, based on the weight of the phosphate ester polyol, of a tri-functional polyether polyol having an equivalent weight less than 2,000 g/mol.

In some embodiments, the polyol component comprises from 1% to 50%, for example, from 2% to 40%, from 3% to 30%, from 3% to 15%, or from 3% to 10% of the phosphate modified polyol, by weight of the polyol component.

In some embodiments, the at least one phosphate modified polyol comprised in the polyol component has an average hydroxyl group number of no less than 80 mg KOH/g. In some embodiments, the at least one phosphate modified polyol comprised in the polyol component has an average hydroxyl group number of no more than 800 mg KOH/g. In some embodiments, the at least one phosphate modified polyol comprised in the polyol component has an average hydroxyl group number that is within the numerical range obtained by combining any two of the following endpoints: 80, 100, 150, 200, 300, 400, 500, 600, 700, 800 mg KOH/g. In some embodiments, the at least one phosphate modified polyol comprised in the polyol component has an average hydroxyl group number of from 80 to 800 mg KOH/g, from 100 to 600 mg KOH/g, from 150 to 500 mg KOH/g, or from 200 to 400 mg KOH/g.

### Vegetable Oil Modified Polyol

At least one vegetable oil modified polyol is comprised in the polyol component. Generally, the at least one vegetable oil modified polyol can function as a hydrophobicity enabler in the polyol component.

As used herein, “vegetable oil modified polyols” refer to vegetable oil based polyether polyols, vegetable oil based polyester polyols, vegetable oil based polyurethane polyols, or mixtures thereof with an average hydroxyl group functionality of no less than 2. In a preferred embodiment, the vegetable oil modified polyols comprise polyurethane polyols and short chain polyether polyols (like Voranol CP 450). In an exemplary embodiment, the vegetable oil modified polyols do not include polyalkene polyols (like polybutadiene polyols). Polyester polyols suitable for use include, but are not limited to, polycondensates of diols and also, optionally, polyols (e.g., triols, tetraols), and of dicarboxylic acids and also, optionally, polycarboxylic acids (e.g., tricarboxylic acids, tetracarboxylic acids) or hydroxycarboxylic acids or lactones. Polyurethane polyol could be synthesized using isocyanates as chain extenders whereas hydroxyl groups as end groups. In some embodiments, the vegetable oil modified polyol comprises a castor oil modified polyol. In some embodiments, the vegetable oil modified polyol comprises a castor oil modified polyurethane polyol.

The polyol component comprises from 1% to 99%, for example, from 2% to 90%, from 3% to 80%, from 5% to 30%, from 5% to 20% or from 5% to 10% of the vegetable oil modified polyol, by weight of the polyol component.

### Additional Polyols

In addition to the phosphate modified polyol and vegetable oil modified polyol as described, the polyol component can comprise one or more additional polyols, for example, one or more selected from polyester polyols, polyether polyols, polyether ester polyols, polycarbonate polyols, polyurethane polyols and their combinations.

In some embodiments, the polyol component comprises one or more polyether polyols. In some embodiments, the one or more polyether polyols comprised in the polyol component have an average hydroxyl group number of no less than 80 mg KOH/g. In some embodiments, the one or more polyether polyols comprised in the polyol component have an average hydroxyl group number of no more than 800 mg KOH/g. In some embodiments, the one or more polyether polyols comprised in the polyol component have an average hydroxyl group number that is within the numerical range obtained by combining any two of the following endpoints: 80, 100, 150, 200, 300, 400, 500, 600, 700, 800 mg KOH/g. In some embodiments, the one or more polyether polyols comprised in the polyol component have an average hydroxyl group number of from 80 to 800 mg KOH/g, from 100 to 600 mg KOH/g, from 150 to 500 mg KOH/g, or from 200 to 400 mg KOH/g.

In some embodiments, the one or more additional polyols comprised in the polyol component have an average hydroxyl group functionality of no more than 4. In some embodiments, the one or more additional polyols comprised in the polyol component have an average hydroxyl group functionality of no less than 2. In some embodiments, the one or more additional polyols in the polyol component have an average hydroxyl group functionality that is within the numerical range obtained by combining any two of the following endpoints: 2, 2.5, 3, 3.5, and 4. In some embodiments, the additional polyols have an average hydroxyl group functionality of from 2 to 4, or from 2 to 3.

In some embodiments, the additional polyols comprise one or more hydrophobic polyols, such as castor oil.

### Optional Additional Additives

The polyol component can, optionally, comprise one or more additional agents for specific functions or purposes.

For example, one or more additional agents selected from the group consisting of chain extenders (e.g., short chain diols), moisture scavengers, catalysts, flame retardants, rheology modifiers, fillers, additional adhesion promoters, and any combination thereof can be further comprised in the polyol component.

In some embodiments, the polyol component can comprise one or more chain extenders (e.g., short chain diols) or crosslinkers. Chain extenders or crosslinkers refer to small molecular weight alcohols with hydroxyl functionality ≥2. Examples are 1,2-methlyene glycol, 1,4-butane diol, glycerol etc. In an exemplary embodiment, the polyol component can comprise 0-10% of chain extenders, by weight of the polyol component.

In some embodiments, the polyol component can comprise one or more moisture scavengers. Moisture scavenger absorbs the moistures from the environment before it reacts with the NCO containing groups in adhesive, helping to solve the bubble formation problem. A common moisture scavenger in a polyurethane adhesive is molecular sieve. In an exemplary embodiment, the polyol component can comprise 0-10% of moisture scavengers by weight of the polyol component.

In some embodiments, the polyol component can comprise one or more catalysts to adjust the reaction kinetics to meet the process requirements. Loading more catalysts helps to build up initial bonding strength but shorts the pot life. A well-balanced catalyst package is organometallic, including Zn, Bi, and Sn-containing catalysts. In an exemplary embodiment, the polyol component can comprise 0-3% catalysts by weight of the polyol component.

In some embodiments, the polyol component can comprise one or more flame retardants. Flame retardants can help improve the fire resistance while battery cell is exposed to electricity short. In an exemplary embodiment, the polyol component can comprise 0-20% flame retardants by weight of the polyol component.

In some embodiments, the polyol component can comprise one or more rheology modifiers. Rheology modifiers are often included in the adhesive formulation to provide the thixotropic properties for different application needs. Rheology modification can be provided by physical association like fume silica, or chemical reaction like amine with NCO. In an exemplary embodiment, the polyol component can comprise 0-10% rheology modifiers by weight of the polyol component.

In some embodiments, the polyol component can comprise one or more fillers. Fillers are added in the adhesive to provide lower costs, thermal conductivity etc. They can be selected from silica, calcium carbonate, kaolin, talc, aluminum hydroxide, alumina, boron nitride etc with or without surface modification. In an exemplary embodiment, the polyol component can comprise 0-95% fillers by weight of the polyol component.

In some embodiments, the polyol component can comprise one or more additional adhesion promoters. The additional adhesion promoters are those other than the phosphate modified polyols as described herein. In an exemplary embodiment, the polyol component can comprise 0-10% additional adhesion promoters by weight of the polyol component.

### (B) Isocyanate Component

The isocyanate component of the polyurethane adhesive composition comprises an NCO-terminated polyurethane prepolymer that is the reaction product of (i) a polyester polyol based on a dimeric acid and an aromatic dicarboxylic acid (“DADPP”), and (ii) an isocyanate monomer.

As used herein, “a polyester polyol based on a dimeric acid and an aromatic dicarboxylic acid”, “a dimeric acid and aromatic dicarboxylic acid based polyester polyol” or “DADPP” refers to a polyester polyol that is derived from, for example, prepared from a reactive mixture of at least one dimeric acid, at least one aromatic dicarboxylic acid, and at least one polyol.

When referring to a “dimeric acid” herein, also included are derivates of the dimeric acid, for example, compounds produced by replacing the hydrogen atom in the dimeric acid molecule with another atom or atomic group (such as halogen or amino group), including halides, anhydrides, esters, salts, amides, etc. of the dimeric acid. Similarly, when referring to an “aromatic dicarboxylic acid” herein, also included are derivates of the aromatic dicarboxylic acid, for example, compounds produced by replacing the hydrogen atom in the aromatic dicarboxylic acid molecule with another atom or atomic group (such as halogen or amino group), including halides, anhydrides, esters, salts, amides, etc. of the aromatic dicarboxylic acid.

Generally, the isocyanate component described herein is solvent-free.

The isocyanate component can optionally comprise one or more additives, for example, plasticizers, flame retardants, adhesion promoters, rheology modifiers, fillers, or any combination thereof.

### NCO-Terminated Polyurethane Prepolymer

The NCO-terminated polyurethane prepolymer comprised in the isocyanate component is a reaction product of at least one polyester polyol and at least one isocyanate monomer, wherein the at least one polyester polyol comprises the DADPP as described herein.

Typically, the NCO-terminated polyurethane prepolymer is prepared by using 35% to 95% by weight of isocyanates and 5% to 65% by weight of the DADPP, based on the weight of the reactive mixture.

The Polyols used for preparing the NCO-terminated polyurethane prepolymer are preferably free of a phosphorous polyol, because it is found by the inventors that the inclusion of a phosphorous polyol can hurt hydrophobicity of Isocyanate side by increasing its moisture sensitivity.

The isocyanate component comprises from 5% to 100%, of the NCO-terminated polyurethane prepolymer, by weight of the isocyanate component. For example, the content of the NCO-terminated polyurethane prepolymer in the isocyanate component is in a range obtained by combining any two of the following endpoints: 5%, 10%, 15%, 20%, 25%, 30%, 35%, 40%, 45%, 50%, 55%, 60%, 65%, 70%, 75%, 80%, 85%, 90%, 95%, 97%, 98%, 99% and 100%. In some embodiments, the isocyanate component comprises from 5%, 10%, 15%, 20%, 25%, 30%, 35%, 40%, or 45%, to 50%, 55%, 60%, 65%, 70%, 75%, 80%, 85%, 90%, 95%, 97%, 98%, 99% or 100% of the NCO-terminated polyurethane prepolymer, by weight of the isocyanate component.

It is understood that the NCO-terminated polyurethane prepolymer is an intermediate between monomers and a final polymer.

### DADPP

The DADPP useful for preparing the NCO-terminated polyurethane prepolymer is prepared from a reactive mixture of at least one dimeric acid, at least one aromatic dicarboxylic acid, and at least one polyol.

It is found by the inventors that the dimeric acid based polyester polyols can bring low viscosity and more importantly, hydrophobicity to the isocyanate component. In addition, the incorporation of an aromatic dicarboxylic acid can not only lower the cost but also promote the adhesion strength into the polyester polyols. In this regard, aliphatic dicarboxylic acids are not desired to be included due to worse hydrophobicity and adhesion strength that could be brought about thereby. For example, the DADPP is not prepared from any adipic acid due to non-hydrophobicity of adipic acid.

The DADPPs are usually polycondensates of diols and, optionally, polyols (e.g., triols, tetraols), and of dimeric acids and aromatic dicarboxylic acid or derivates thereof. The hydroxyl groups of the DADPPs will further react with isocyanates to produce the polyurethane prepolymers.

In some embodiments, the DADPP is prepared via a one-step process, where all the acids and alcohols were charged one-pot and reacted in one step.

In some embodiments, the weight ratio of aromatic dicarboxylic acid to dimeric acid is >0 and <4.2. In some embodiments, the weight ratio of aromatic dicarboxylic acid to dimeric acid is >0 and <3. In some embodiments, the weight ratio of aromatic dicarboxylic acid to dimeric acid is >0 and <2.5. In some embodiments, the weight ratio of aromatic dicarboxylic acid to dimeric acid is >0 and <2.0. In some embodiments, the weight ratio of aromatic dicarboxylic acid to dimeric acid is >0 and <1.5. In some embodiments, the weight ratio of aromatic dicarboxylic acid to dimeric acid is >0 and <1. In some embodiments, the weight ratio of aromatic dicarboxylic acid to dimeric acid is >0 and <0.6.

### Dimeric Acid

A “dimeric acid” useful for preparing the DADPP can be a dicarboxylic acid compound obtained by allowing a fatty acid having one, two, three, or four ethylenic double bonds and from 14 to 22 (e.g., from 16 to 20) carbon atoms (hereinafter referred to as “Unsaturated Fatty Acid A”), and a fatty acid having one, two, three, or four ethylenic double bonds and from 14 to 22 (e.g., from 16 to 20) carbon atoms (hereinafter referred to as an “Unsaturated Fatty Acid B”), to react on double bonds in a dimerization reaction. In an embodiment, Unsaturated Fatty Acid A has two ethylenic double bonds and from 14 to 22 (e.g., from 16 to 20) carbon atoms, and the Unsaturated Fatty Acid B has one or two ethylenic double bonds and from 14 to 22 (e.g., from 16 to 20) carbon atoms. Non-limiting examples of suitable Unsaturated Fatty Acid A include tetradecadienoic acids, hexadecadienoic acids, octadecadienoic acids (such as linoleic acid), eicosadienoic acids, docosadienoic acids, octadecatrienoic acids (such as linolenic acid), eicosatetraenoic acids (such as arachidonic acid), and combinations thereof. Non-limiting examples of suitable Unsaturated Fatty Acid B include the above examples, as well as tetradecenoic acids (tsuzuic acid, physeteric acid, myristoleic acid), hexadecenoic acids (such as palmitoleic acid), octadecenoic acids (such as oleic acid, elaidic acid, and vaccenic acid), eicosenoic acids (such as gadoleic acid), and docosenoic acids (such as erucic acid, setoleic acid, and brassidic acid), and combinations thereof.

The obtained dimeric acid can be a mixture of dimeric acids, the structures of which differ according to the binding site or isomerization of a double bond.

In some embodiments, the dimeric acids useful for preparing the NCO-terminated polyurethane prepolymer can be selected from the group consisting of acyclic dimeric acids, cyclic dimeric acids, aromatic dimeric acids, polycyclic dimeric acids, and any combination thereof.

For example, the acyclic dimeric acid can be represented by structure (A) or (B):

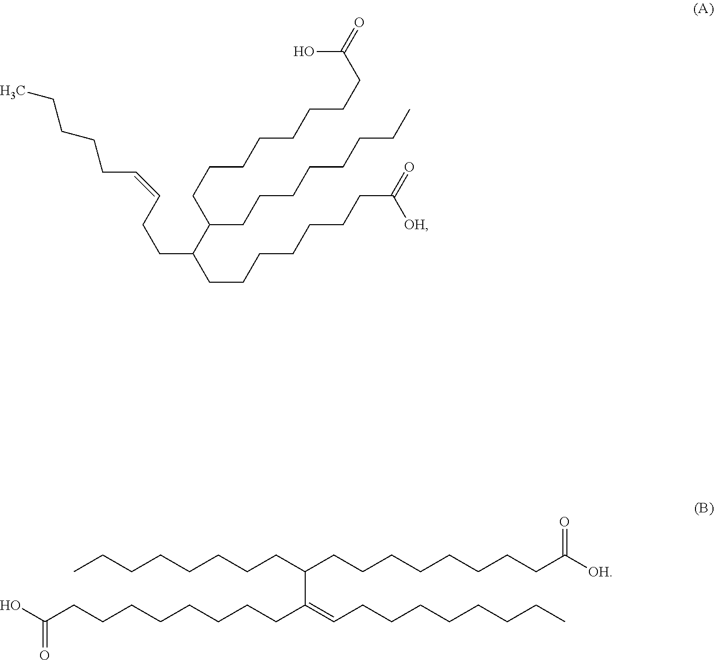

The cyclic dimeric acid can be represented by structure (C):

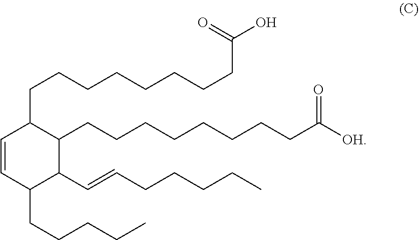 [SMILES: CCCCC/C=C/C1C(CCCCC)C=CC(CCCCCCCCC(=O)O)C1CCCCCCCCC(=O)O]

The aromatic dimeric acid can be represented by structure (D):

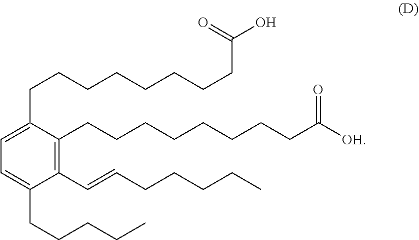 [SMILES: CCCCC/C=C/c1c(CCCCC)ccc(CCCCCCCCC(=O)O)c1CCCCCCCCC(=O)O]

The polycyclic dimeric acid can be represented by structure (E):

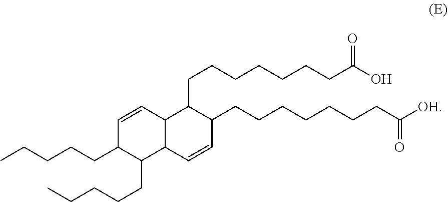 [SMILES: CCCCCC1C=CC2C(C=CC(CCCCCCCC(=O)O)C2CCCCCCCC(=O)O)C1CCCCC]

In some embodiments, the dimeric acid can be a C36 dimeric acid. In further embodiments, the C36 dimeric acid has the Structure (A).

In an embodiment, the dimeric acid is unsaturated. An “unsaturated dimeric acid” includes at least one carbon-carbon double bond. For example, Structure (A) is an unsaturated dimeric acid. A non-limiting example of a suitable dimeric acid is ATUREX-1001 (CAS 61788-89-4), available from Aturex Group.

In an embodiment, the dimeric acid has an acid value of from 150 mg KOH/g, or 160 mg KOH/g, or 170 mg KOH/g, or 180 mg KOH/g, or 190 mg KOH/g, or 194 mg KOH/g to 200 mg KOH/g, or 210 mg KOH/g, or 220 mg KOH/g, or 230 mg KOH/g, or 240 mg KOH/g, or 250 mg KOH/g. In another embodiment, the dimeric acid has an acid value of from 150 mg KOH/g to 250 mg KOH/g, or from 180 mg KOH/g to 220 mg KOH/g, or from 190 mg KOH/g to 200 mg KOH/g.

In an embodiment, the dimeric acid has the Structure (A) and has an acid value of from 150 mg KOH/g to 250 mg KOH/g, or from 180 mg KOH/g to 220 mg KOH/g, or from 190 mg KOH/g to 200 mg KOH/g.

In some embodiments, the DADPP comprises from 5% to 80%, for example, from 10% to 75%, from 15% to 70%, or from 20% to 65% of at least one dimeric acid, by the weight the DADPP.

In some embodiments, the NCO-terminated polyurethane prepolymer comprises from 1% to 20%, for example, from 2% to 18%, from 3% to 17%, or from 3% to 15% of at least one dimeric acid, by the weight of the prepolymer.

### Aromatic Dicarboxylic Acid

An aromatic dicarboxylic acid useful for preparing the DADPP is not a dimeric acid as described above. In other words, the aromatic dicarboxylic acid is structurally distinct and/or compositionally distinct from the dimeric acid in the reaction mixture.

In some embodiments, the aromatic dicarboxylic acid comprises carboxyl groups connected directly to an aromatic ring. In some embodiments, the aromatic dicarboxylic acid does not comprise an olefinic bond.

In some embodiments, the aromatic dicarboxylic acid can be selected from the group consisting of phthalic acid, isophthalic acid, terephthalic acid, and any combination thereof. In some embodiments, the aromatic dicarboxylic acid comprises isophthalic acid.

In some embodiments, the DADPP comprises from 5% to 80%, for example, from 10% to 70%, from 12% to 60%, or from 15% to 55% of at least one aromatic dicarboxylic acid, by the weight the DADPP.

In some embodiments, the NCO-terminated polyurethane prepolymer comprises from 0.5% to 20%, for example, from 1% to 18%, from 2% to 15%, or from 3% to 12% of at least one aromatic dicarboxylic acid, by the weight of the prepolymer.

### Polyol

A polyol useful for preparing the DADPP can be selected from the group consisting of diols, triols, tetraols and combinations thereof.

As used herein, the term “polyol” refers to a compound with two or more hydroxyl groups. A polyol is a “diol” when it has exactly two hydroxyl groups, a “triol” when it has exactly three hydroxyl groups, a “tetraol” when it has exactly four hydroxyl groups, a “pentanol” when it has exactly five hydroxyl groups, and so on.

Non-limiting examples of suitable diols include 3-methyl 1,5-pentane diol (MPD); 2-methyl-1,3-propanediol (MPG); ethylene glycol; butylene glycol; diethylene glycol (DEG); triethylene glycol; polyalkylene glycols, such as polyethylene glycol and polypropylene glycol; 1,2-propanediol; 1,3-propanediol; 1,3-butanediol; 1,4-butanediol; 1,6-hexanediol; and neopentyl glycol (NPG). In some embodiments, the polyol comprises a diol. In a further embodiment, the diol comprises MPG and/or 1,6-hexanediol.

A non-limiting example of a suitable triol is trimethylolpropane (TMP).

In some embodiments, the one or more polyols used for preparing the DADPP have an average hydroxyl group functionality of no more than 4. In some embodiments, the one or more polyols used for preparing the DADPP have an average hydroxyl group functionality of no less than 2. In some embodiments, the one or more polyols used for preparing the DADPP have an average hydroxyl group functionality that is within the numerical range obtained by combining any two of the following endpoints: 2, 2.5, 3, 3.5, and 4. In some embodiments, the one or more polyols used for preparing the DADPP have an average hydroxyl group functionality of from 2 to 4, for example, from 2 to 3.

### Isocyanate Monomer

The isocyanate monomers useful for preparing the NCO-terminated polyurethane prepolymer can comprise various unmodified or modified monomeric isocyanates.

As used herein, an “isocyanate monomer” or a “monomeric isocyanate” is any compound that comprises two or more isocyanate groups.

Compounds having isocyanate groups, such as the isocyanate monomers, may be characterized by the parameter “% NCO,” or “—NCO content”, which is the amount of isocyanate groups by weight of the compound. In some embodiments, the isocyanate monomer has a free-NCO content of between 15% and 40%, for example, between 18% and 35%, by weight of the isocyanate monomer.

Examples of monomeric aromatic isocyanates suitable for use according to the disclosure include, but are not limited to, isomers of methylene diphenyl diisocyanate (“MDI”) such as 4,4-MDI, 2,4-MDI and 2,2′-MDI, or modified MDI such as carbodiimide modified MDI or allophanate modified MDI; isomers of toluene-diisocyanate (“TDI”) such as 2,4-TDI, 2,6-TDI, isomers of naphthalene-diisocyanate (“NDI”) such as 1,5-NDI, m-and p-phenylene diisocyanate, chlorophenylene-2,4-diisocyanate, diphenylene-4,4′-diisocyanate, 3,3′-dimethyl-4,4′-diphenyl-diisocyanate, 3-methyldiphenyl-methane-4,4′-diisocyanate, diphenyletherdiisocyanate, 2,4,6-triisocyanatotoluene, 2,4,4′-triisocyanatodiphenylether, and combinations thereof.

In some embodiments, the isocyanate monomer can be selected from the group consisting of MDI, TDI, IPDI, HMDI and any combination thereof. In some embodiments, MDI is comprised for better mechanical properties. The types of MDI include linear MDI like 4,4′-MDI, 2,2′-MDI, carbodiimide modified MDI and mixtures thereof. Polymeric MDI can also be used for adjusting the mechanical properties but is not preferred because it is found to be more sensitive to moistures (for example, compared to carbodiimide-containing isocyanates).

In some embodiments, one or more of the isocyanate monomers comprised are carbodiimide modified. In some embodiments, the isocyanate monomers comprises carbodiimide modified MDI.

### Optional Additional Additives

The isocyanate component can, optionally, comprise one or more additional agents for specific functions or purposes.

For example, one or more additional agents selected from the group consisting of plasticizers, flame retardants, other adhesion promoters, rheology modifiers, fillers, and any combination thereof can be further comprised in the isocyanate component.

In some embodiments, the isocyanate component can comprise one or more plasticizers to reduce the skinning accumulated during the application of the isocyanate component. In an exemplary embodiment, the isocyanate component can comprise 0-20% plasticizers by weight of the isocyanate component.

In some embodiments, the isocyanate component can comprise one or more flame retardants to improve the fire resistance. In an exemplary embodiment, the isocyanate component can comprise 0-20% flame retardants by weight of the isocyanate component.

In some embodiments where the isocyanate component is used as an isocyanate component in a polyurethane adhesive composition, the isocyanate component can comprise one or more adhesion promoters for increased adhesion between substrates. In an exemplary embodiment, the isocyanate component can comprise 0-10% other adhesion promoters by weight of the isocyanate component. In the embodiments where the isocyanate component is used as an isocyanate component in the polyurethane adhesive composition as described herein, the adhesion promoters comprised in the isocyanate component are other than the phosphate modified polyols as described herein.

In some embodiments, the isocyanate component can comprise one or more rheological modifiers to provide the thixotropic properties for different application needs. Rheology modification can be provided by physical association like fume silica, or chemical reaction like amine with NCO. In an exemplary embodiment, fume silica with hydrophobic surface treatment can be used as a rheology modifier in the isocyanate component. In an exemplary embodiment, the isocyanate component can comprise 0-10% rheology modifiers by weight of the isocyanate component.

In some embodiments, the isocyanate component can comprise one or more fillers to further lower costs, thermal conductivity etc. The fillers can be selected from silica, calcium carbonate, kaolin, talc, aluminum hydroxide, alumina, boron nitride etc with or without surface modification. In an exemplary embodiment, the isocyanate component can comprise 0-95% fillers by weight of the isocyanate component.

### B. Isocyanate Agent

In an aspect, the present disclosure provides an isocyanate agent, comprising an NCO-terminated polyurethane prepolymer that is the reaction product of (i) a polyester polyol based on a dimeric acid and an aromatic dicarboxylic acid (“DADPP”), and (ii) an isocyanate monomer.

The isocyanate agent comprises or is one of the isocyanate components, or, a mixture of the isocyanate components, as described in the “(B) Isocyanate component” portion above, and is prepared, packaged, stored and transported as an independent product.

In some embodiments, the isocyanate agent is for use in a polyurethane adhesive composition. For example, the isocyanate agent can be used as an isocyanate component in the polyurethane adhesive composition according to the present disclosure, which can be mixed and react with the polyol component to produce a polyurethane adhesive.

### C. Application of the Polyurethane Adhesive Composition

In a further aspect, the present disclosure provides a method of using the polyurethane adhesive composition as described herein, comprising:
(a) providing the polyurethane adhesive composition comprising a polyol component and an isocyanate component as described;
(b) bringing the polyol component and the isocyanate component into contact, to form a curable mixture;
(c) applying the curable mixture to a first substrate to which at least a second substrate is to be bonded;
(d) bringing the second substrate into contact with the first substrate so that at least a portion of the curable mixture is sandwiched between the first substrate and the second substrate; and
(e) curing the curable mixture or allowing it to cure.

In some embodiments, the curable mixture can be cured at a room temperature (about 25° C.) for several days (for example, 3 to 10 days). In some embodiments, the curable mixture can be subjected to pressure or heat (for example, at a temperature of from 30° C. to 90° C., for example, from 30° C. to 60° C.) to speed the curing.

The material or type of the substrate to be treated (for example, the first substrate and the second substrate) by the polyurethane adhesive composition is not limited. In an exemplary embodiment, the first substrate can be one or more battery cells and the second substrate can be a cooling plate.

In a further aspect, the present application provides the use of the polyurethane adhesive composition as described in a battery pack.

### EXAMPLES

Some embodiments of the invention will now be described in the following Examples, wherein all parts and percentages are by weight unless otherwise specified.

TABLE 1
Raw materials
Raw materials used in this ICD

| Category | Chemical Name | Specification | Supplier |
|---|---|---|---|
| Polyol | Castor Oil | OH value 163, density 0.961 g/cm³, | Guangzhou Hanhao |
| | | functionality 2.7 | Chemcial Co. Ltd. |
| Polyol | VORANOL ™ CP 450 | Polyether polyol, OH value 373, | The DOW Chemical |
| | | density 1.01 g/cm³, functionality 3 | Company |
| Polyol | VORANOL ™ P 400 | Polyether polyol, OH value 260, | The DOW Chemical |
| | | density 1.01 g/cm³, functionality 2 | Company |
| Chain Extender | 1,4-BDO | Molecular weight 90, density 1.01 | SinoChem Group |
| | | g/cm³, functionality 2 | Co. Ltd. |
| Diacid | Isophthalic acid | Molecular weight 166.13, functionality | Sigma-Aldrich |
| | | 2 | |
| Anhydride | Phthalic Anhydride | Molecular weight 148.12, functionality | Sigma-Aldrich |
| | | 2 | |
| Dimeric Acid | ATUREX-1001 | Acid value 194-200, dibasic acid > 98% | ATUREX |
| | | | Chemicals |
| Diol | 2-Methyl-1,3-Propane diol | Molecular weight 90 | Sigma-Aldrich |
| Diol | 1,6-Hexanediol | Molecular weight 118 | Sigma-Aldrich |
| Catalyst | Tyzor TBT | Density 1.00 g/cm³, CAS No. | Sigma-Aldrich |
| | | 5593-70-4 | |
| Isocyanate | ISONATE ™ 143L | Carbodiimide modified MDI. NCO | The DOW Chemical |
| | | content 29%, functionality 2 | Company |
| Isocyanate | ISONATE ™ OP 50 | NCO content 33.5%, functionality 2 | The DOW Chemical |
| | | | Company |
| Adhesion Promoter | Phosphate Modified | OH value 295, density 1.3 g/cm³ | The DOW Chemical |
| | Polyol (polyether based | | Company |
| | polyurethane polyol) | | |
| Adhesion Promoter | 3-Glycidoxypropyl | Density 1.07 g/cm³ | The DOW Chemical |
| | Trimethoxysilane, Z-6040 | | Company |
| Flame Retardant | IPPP (Isopropylated | Density 1.17 g/cm³ | Suzhou Dongtuo |
| | Phosphate Phenol) | | Chemical Co. Ltd. |
| Plasticizer | DINP (Diisononyl | Density 0.975 g/cm³ | Zhuhai Liancheng |
| | Phalate) | | Chemical Co. Ltd. |
| Moisture Scavenger | Molecular Sieve 3A | Density 2.1 g/cm³ | GRACE |
| Rheology Modifier | Fume silica, AEROSIL R | Hydrophobically modified, density 2.1 | EVONIK Industries |
| | 974 | g/cm³ | AG |
| Rheology Modifier | Fume silica, H-18 | Hydrophobically modified, density 2.1 | EVONIK Industries |
| | | g/cm³ | AG |
| Filler | Aluminum Hydroxide | Density 2.4 g/cm³ | Shandong Shibang |
| | (ATH), 18 μm | | Co., Ltd. |
| Filler | Alumina (Al₂O₃), 40 μm | Density 3.5 g/cm³ | Shanghai Bestry |
| | | | Performance |
| | | | Materials Co., Ltd. |
| Filler | Boron Nitride | Density 2.25 g/cm³ | Saint-Gobain Group |

### Synthesis Processes

### Synthesis of Dimeric Acid Based Polyester Polyol-1 (DA-1):

100 g 1,6-Hexanediol, 353 g ATUREX-1001 were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Dimeric Acid Based Polyester Polyol-2 (DA-2):

100 g 2-mehtyl-1,3-propane diol, 467.5 g ATUREX-1001 were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Dimeric Acid/Adipic Acid Based Polyester Polyol (DAAP):

100 g 2-mehtyl-1,3-propane diol, 54.3 g ATUREX-1001, 129.9 g Adipic Acid were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Dimeric Acid/Isophthalic Acid Based Polyester Polyol-1 (DAIA-1):

100 g 2-mehtyl-1,3-propane diol, 36.7 g ATUREX-1001, 152.4 g isophthalic acid were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Dimeric Acid/Isophthalic Acid Based Polyester Polyol-2 (DAIA-2):

100 g 2-mehtyl-1,3-propane diol, 68.2 g ATUREX-1001, 141.4 g isophthalic acid were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Dimeric Acid/Isophthalic Acid Based Polyester Polyol-3 (DAIA-3):

100 g 2-mehtyl-1,3-propane diol, 107.7 g ATUREX-1001, 127.6 g isophthalic acid were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Dimeric Acid/Isophthalic Acid Based Polyester Polyol-4 (DAIA-4):

100 g 2-mehtyl-1,3-propane diol, 175.2 g ATUREX-1001, 103.8 g isophthalic acid were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Dimeric Acid/Isophthalic Acid Based Polyester Polyol-5 (DAIA-5):

100 g 2-mehtyl-1,3-propane diol, 255.4 g ATUREX-1001, 75.6 g isophthalic acid were charged into 500 ml glass reactor and mixed completely. The mixture was heated to 100° C. When the raw materials turned to liquid, agitation was started. The temperature was controlled on the proper position and monitored in the whole process. If the top temperature of glass condenser increased above 103° C., cooling of the reactor was started as soon as possible. When the reaction temperature increased to 220° C., top temperature fell below 100° C., vacuum was applied slowly in 30 minutes to 30 mm Hg. The acid value was checked every 30 minutes. A certain amount of catalyst Tyzor TBT was added until acid value of the reaction system was less than 10. Catalyst was added and the reaction system was maintained at 30 mm Hg vacuum condition for more than 1 hour until the OH value reached theoretical value. The temperature was cooled down to 60-70° C., and the final product was collected as dimeric acid based polyester polyol.

### Synthesis of Caster Oil Modified Polyol (Polyurethane Polyol):

The polyurethane polyol was synthesized in 1,000 ml glass reactor as normal polyurethane pre-polymer preparation process. 12 g ISONATE OP 50 was charged into reactor and keep them at 60° C. with nitrogen protection, then 44 g castor oil and 44 g VORANOL P 400 were charged into reactor to mix with ISONATE OP 50. Increase the temperature to 80° C. slowly and hold for 2 hours. The polyurethane polyol was finally charged into a well-sealed container with nitrogen protection for further use.

### Synthesis of NCO-terminated Prepolymer of DA-1 (Pre-DA1):

75 g ISONATE 143L was charged into 1,000ml glass reactor and keep them at 60° C. with nitrogen protection, then 25 g DA-1 was charged into reactor to mix with ISONATE 143L. Increase the temperature to 80° C. slowly and hold for 2-3 hour until NCO content meet the theoretical value. Finally, pre-polymer was charged into well sealed container with nitrogen protection for further application.

### Synthesis of NCO-terminated Prepolymer of DA-2 (Pre-DA2):

75 g ISONATE 143L was charged into 1,000ml glass reactor and keep them at 60° C. with nitrogen protection, then 25 g DA-2 was charged into reactor to mix with ISONATE 143L. Increase the temperature to 80° C. slowly and hold for 2-3 hours until NCO content meet the theoretical value. Finally, pre-polymer was charged into well sealed container with nitrogen protection for further application.

### Synthesis of NCO-terminated Prepolymer of DAAP (Pre-DAAP):

75 g ISONATE 143L was charged into 1,000ml glass reactor and keep them at 60° C. with nitrogen protection, then 25 g DAAP was charged into reactor to mix with ISONATE 143L. Increase the temperature to 80° C. slowly and hold for 2-3 hours until NCO content meet the theoretical value. Finally, pre-polymer was charged into well sealed container with nitrogen protection for further application.

### Synthesis of NCO-terminated Prepolymers of DAIA-1 (Pre-DAIA1):

75 g ISONATE 143L was charged into 1,000ml glass reactor and keep them at 60° C. with nitrogen protection, then 25 g DAIA-1 was charged into reactor to mix with ISONATE 143L. Increase the temperature to 80° C. slowly and hold for 2-3 hours until NCO content meet the theoretical value. Finally, pre-polymer was charged into well sealed container with nitrogen protection for further application.

### Synthesis of NCO-terminated Prepolymers of DAIA-2 (Pre-DAIA2):

75 g ISONATE 143L was charged into 1,000ml glass reactor and keep them at 60° C. with nitrogen protection, then 25 g DAIA-2 was charged into reactor to mix with ISONATE 143L. Increase the temperature to 80° C. slowly and hold for 2-3 hours until NCO content meet the theoretical value. Finally, pre-polymer was charged into well sealed container with nitrogen protection for further application.

### Synthesis of NCO-terminated Prepolymers of DAIA-3 (Pre-DAIA3):

75 g ISONATE 143L was charged into 1,000ml glass reactor and keep them at 60° C. with nitrogen protection, then 25 g DAIA-3 was charged into reactor to mix with ISONATE 143L. Increase the temperature to 80° C. slowly and hold for 2-3 hours until NCO content meet the theoretical value. Finally, pre-polymer was charged into well sealed container with nitrogen protection for further application.

### Synthesis of NCO-terminated Prepolymers of DAIA-4 (Pre-DAIA4):

75 g ISONATE 143L was charged into 1,000ml glass reactor and keep them at 60° C. with nitrogen protection, then 25 g DAIA-4 was charged into reactor to mix with ISONATE 143L. Increase the temperature to 80° C. slowly and hold for 2-3 hours until NCO content meet the theoretical value. Finally, pre-polymer was charged into well sealed container with nitrogen protection for further application.

### Synthesis of NCO-terminated Prepolymers of DAIA-5 (Pre-DAIA5):

75 g ISONATE 143L was charged into 1,000ml glass reactor and keep them at 60° C. with nitrogen protection, then 25 g DAIA-5 was charged into reactor to mix with ISONATE 143L. Increase the temperature to 80° C. slowly and hold for 2-3 hours until NCO content meet the theoretical value. Finally, pre-polymer was charged into well sealed container with nitrogen protection for further application.

All prepolymers were successfully synthesized.

### Formulations and Effects

Isocyanate agents (to be used as Part B in a polyurethane adhesive composition) were formulated as shown in Table 2, all of which met moisture-resistance requirements.

TABLE 2
Part B Formulations Tested (Tack Free Time ≥ 8.0 h, must)

| Isocyanate agent (Part B) | | E-01 | E-02 | E-03 | E-04 | E-05 | E-06 | E-07 | E-08 |
|---|---|---|---|---|---|---|---|---|---|
| Prepolymers | Pre-DA1 | 37.84 | | | | | | | |
| | Pre-DA2 | | 37.84 | | | | | | |
| | Pre-DAAP | | | 37.84 | | | | | |
| | Pre-DAIA1 | | | | 37.84 | | | | |
| | Pre-DAIA2 | | | | | 37.84 | | | |
| | Pre-DAIA3 | | | | | | 37.84 | | |
| | Pre-DAIA4 | | | | | | | 37.84 | |
| | Pre-DAIA5 | | | | | | | | 37.84 |
| Diisononyl Phalate (DINP) | | 0.54 | 0.54 | 0.54 | 0.54 | 0.54 | 0.54 | 0.54 | 0.54 |
| Isopropylated | | 0.54 | 0.54 | 0.54 | 0.54 | 0.54 | 0.54 | 0.54 | 0.54 |
| Phosphate Phenol (IPPP) | | | | | | | | | |
| Z-6040 | | 0.81 | 0.81 | 0.81 | 0.81 | 0.81 | 0.81 | 0.81 | 0.81 |
| AEROSIL R 974 | | 0.81 | 0.81 | 0.81 | 0.81 | 0.81 | 0.81 | 0.81 | 0.81 |
| Boron Nitride | | 2.70 | 2.70 | 2.70 | 2.70 | 2.70 | 2.70 | 2.70 | 2.70 |
| Alumina (Al₂O₃) | | 56.76 | 56.76 | 56.76 | 56.76 | 56.76 | 56.76 | 56.76 | 56.76 |
| Total | | 100 | 100 | 100 | 100 | 100 | 100 | 100 | 100 |
| Tacky Free Time, h | | 10 | 9 | 6.5 | 7 | 8.5 | 9 | 10 | 10 |
| Cost of B Part | | Expensive | Expensive | low | low | low | low | low | low |
| Adipic Acid Content in | | 0.0 | 0.0 | 45.7 | 0.0 | 0.0 | 0.0 | 0.0 | 0.0 |
| Polyester (%) | | | | | | | | | |
| Isophthalic Acid Content | | 0.0 | 0.0 | 0 | 52.7 | 45.7 | 38.1 | 27.4 | 17.5 |
| In Polyesters (%) | | | | | | | | | |
| Dimeric Acid Content | | 77.9 | 82.4 | 23.2 | 12.7 | 22.0 | 32.1 | 46.2 | 59.3 |
| In Polyesters (%) | | | | | | | | | |
| Isophthalic Acid Content | | 0.0 | 0.0 | 0 | 13.2 | 11.4 | 9.5 | 6.8 | 4.4 |
| In Prepolymers (%) | | | | | | | | | |
| Dimeric Acid Content | | 19.5 | 20.6 | 5.8 | 3.2 | 5.5 | 8.0 | 11.6 | 14.8 |
| In Prepolymers (%) | | | | | | | | | |
| Wt. Ratio (dicarboxylic | | 0.0 | 0.0 | 2.1 | 4.2 | 2.1 | 1.2 | 0.6 | 0.3 |
| Acid/Dimeric Acid) | | | | | | | | | |

E-01 and E-02 showed good hydrophobicity, but their costs are high. Besides, the adhesion strength of E-02 was not satisfactory as will be detailed later. Comparison is made between E02 to E03 and E04 to E08, and it is found that:
(1) When the weight ratio of isophthalic acid/dimeric acid >0 and <0.6, the hydrophobicity of the isocyanate parts was improved.
(2) When the weight ratio of isophthalic acid/dimeric acid >0.6 and <4.2, the hydrophobicity of the isocyanate parts was deteriorated, but is still acceptable.
(3) When the weight ratio of isophthalic acid/dimeric acid >4.2, the hydrophobicity of the isocyanate parts was not acceptable.
(4) If change the isophthalic acid to aliphatic dicarboxylic acid (carbon number ≤6), even if the dicarboxylic acid/dimeric acid <4.2, the hydrophobicity of the isocyanate parts was not acceptable.

Polyurethane adhesive compositions were further prepared.

The adhesive formulations, with details in Part A and the corresponding examples of Part B, are summarized in Table 3. The adhesive application machines are mostly available at 1:1 volume mixing ratio. To ensure adhesive fully cured, the stoichiometric ratio of 2K polyurethane adhesive is usually set in the range of 1.05-1.85. So, the formulations were designed to meet these requirements. The Volume mixing ratio and stoichiometric ratio were calculated and listed in Table 3.

TABLE 3
Adhesive Examples

| | Com. 01 | Com. 02 | Com. 03 | Com. 04 | Inv. 01 | Inv. 02 | Inv. 03 | Inv. 04 |
|---|---|---|---|---|---|---|---|---|
| Part A | | | | | | | | |
| Castor Oil | 16.90 | 16.90 | 16.90 | 16.90 | 16.90 | 16.90 | 16.90 | 16.90 |
| Castor Oil Modified Polyol | 7.04 | 7.04 | 7.04 | 7.04 | 7.04 | 7.04 | 7.04 | 7.04 |
| Phosphate Modified Polyol | 4.70 | 4.70 | 4.70 | 4.70 | 4.70 | 4.70 | 4.70 | 4.70 |
| VORANOL CP 450 | 4.23 | 4.23 | 4.23 | 4.23 | 4.23 | 4.23 | 4.23 | 4.23 |
| 1,4-BDO | 2.11 | 2.11 | 2.11 | 2.11 | 2.11 | 2.11 | 2.11 | 2.11 |
| Molecular Sieve 3A | 3.99 | 3.99 | 3.99 | 3.99 | 3.99 | 3.99 | 3.99 | 3.99 |
| Fume Silica, H-18 | 1.64 | 1.64 | 1.64 | 1.64 | 1.64 | 1.64 | 1.64 | 1.64 |
| Aluminum Hydroxide (ATH) | 59.39 | 59.39 | 59.39 | 59.39 | 59.39 | 59.39 | 59.39 | 59.39 |
| Total | 100 | 100 | 100 | 100 | 100 | 100 | 100 | 100 |
| Part B | | | | | | | | |
| E01 | 118.0 | | | | | | | |
| E02 | | 118.0 | | | | | | |
| E03 | | | 118.0 | | | | | |
| E04 | | | | 118.0 | | | | |
| E05 | | | | | 118.0 | | | |
| E06 | | | | | | 118.0 | | |
| E07 | | | | | | | 118.0 | |
| E08 | | | | | | | | 118.0 |
| ISO Index, NCO/OH | 1.19 | 1.19 | 1.19 | 1.19 | 1.19 | 1.19 | 1.19 | 1.19 |
| Volume ratio, B/A | 1.00 | 1.00 | 1.00 | 1.00 | 1.00 | 1.00 | 1.00 | 1.00 |
| Lap-shear Strength, MPa | | | | | | | | |
| Mean from 5 measurements | 11.80 | 9.16 | 8.10 | 6.52 | 12.53 | 10.45 | 11.33 | 11.13 |
| Cross-tensile Strength, MPa | | | | | | | | |
| Mean from 5 measurements | 14.44 | 12.15 | 8.50 | 12.35 | 22.15 | 21.57 | 21.40 | 20.37 |
| Wt. Ratio (Isophthalic Acid/ | 0.0 | 0.0 | 0.0 | 4.2 | 2.1 | 1.2 | 0.6 | 0.3 |
| Dimeric Acid) | | | | | | | | |
| Tacky Free Time Isocyanate | 10 | 9 | 6.0 | 6.5 | 8 | 8.5 | 9.5 | 9.5 |
| Part, h | | | | | | | | |
| Cost of Part B | High | High | low | low | low | low | low | low |

Note:
Com.—Comparative Example; Inv.—Inventive Example. Lap-shear Strength ≥ 8.5 Mpa and Cross-tensile Strength ≥ 12.5 MPa are preferred.

Com.01-Com.03 as comparative examples showed that,
(1) compositions based on pure dimeric acid polyesters are high in cost and might harm the adhesion strength (E-02)
(2) the prepolymer based on polyesters of adipic acid and dimeric acid harmed the adhesion strength (Com. 03)

Comparing Com. 04 with Inv. 01 to 04, it is found that when the weight ratio of isophthalic acid/dimeric acid ≥4.2, the hydrophobicity of the isocyanate part was unacceptable. Besides, the adhesion strength could be significantly harmed.

Comparing Com. 01 to 02 with Inv. 01 to 04, it is found that when the weight ratio of isophthalic acid/dimeric acid <4.2, cross tensile strengths were greatly increased.

Comparing Com. 03 with Inv. 01, the weight ratio between the dicarboxylic acid and dimeric acid was the same, however, both the hydrophobicity and adhesion strength were deteriorated.

### Methods and Tests

Part B isocyanate prepolymer was prepared following the procedure below:
Step 1 Charge NCO-terminated prepolymer into the vessel; then add other liquid components (DINP, IPPP, Z-6040, etc.)
Step 2 Apply vacuum and mix with medium stirring rates for 30 min;
Step 3 Charge alumina into the vessel: apply vacuum after powder incorporation; mix with high stirring rates for 30 min;
Step 4 Charge fumed silica into the vessel; apply vacuum after powder incorporation; mix with high stirring rates for 1 hour;
Step 5 Set temperature bath to 80° C.; keep mixing with medium to low stirring rates for 30 min to sustain the temperature;
Step 6 Set temperature bath to 20° C. to cool down to <40° C.;

Tacky free time was tested following procedure below: (ASTM C679-03)
Take 10g part B in a 50 ml Plastic beaker, put the beaker in oven under 45% humidity and 23° C. temperature. Start time recording. Periodically take out the beaker and use a plastic stick to touch the surface of part B softly. With the increasing reaction between part B and moisture, the surface viscosity increases. Stop the time recording when surface of part B is not sticky anymore. The duration is recorded as tacky free time of part B.

Part A polyol mixture is prepared following the procedure below:
Step 1 Charge castor oil, polyurethane polyol, CP450, and BDO into the vessel
Step 2 Heat up to 80° C.; apply vacuum and mix with medium stirring rates for 1 hour to de-gas.
Step 3 Charge ATH into the vessel, apply vacuum after powder incorporation; mix with high stirring rates for 15 min;
Step 4 Charge Molecular Sieve 3A into the vessel: apply vacuum after powder incorporation; mix with high stirring rates for 15 min;
Step 5 Charge H-18 into the vessel: apply vacuum after powder incorporation; mix with high stirring rates for 1 hour;
Step 6 Cool down to <40° C.

Lap-joint test coupons were made with the procedure below: (GB/T7124)
1. Substrate is made by 3003 aluminum alloy with a dimension of 25 mm×12.5 mm.
2. Clean the substrate surface by wiping off with ethanol.
3. Mask out 25 mm×12 mm bonding area by using pressure sensitive tape.
4. Mix the Part A and Part B of adhesive and put in speedmixer at 1,000 rpm for 1 min to make sure thoroughly mixing.
5. Apply 0.5 g to 1.5 g adhesive in the bonding area of the substrate. Put two copper wires with diameter 0.25 mm to control the thickness of adhesive.
6. Along the length direction, stack another masked substrate with the same bonding area contacted head-to-head. Press and fasten the bonding surfaces with two clippers side by side.
7. Cure the adhesive at 25° C. for 7 days.

Butt-joint test coupons were made based on procedure below: (GB/T6329)
1. Substrate is made by 3003 aluminum alloy with a dimension of 60 mm height and 15 mm diameter.
2. Clean the substrate surface by wiping off with ethanol.
3. Mix the Part A and Part B of adhesive and put in speedmixer at 1,000 rpm for 1 min to make sure thoroughly mixing.
4. Apply 0.5 g to 1 g adhesive on the flat surface of substrate. Put two copper wires with diameter 1.00 mm to control the thickness of adhesive.
5. Stack another cleaned substrate with the flat surface bonded together. Keep the stacked substrates vertically so the bonding surfaces can be constantly fastened by gravity force.
6. Cure the adhesive at 25° C. for 7 days.

Test coupons were assembled on the fixture of Instron test machine and tested at strain rate of 5 mm/min for shear strength of lap-joints and tensile strength of butt-joints.

What is claimed is:

1. A polyurethane adhesive composition, comprising,
(a) a polyol component, comprising a phosphate modified polyol and a vegetable oil modified polyol, and
(b) an isocyanate component, comprising an NCO-terminated polyurethane prepolymer that is the reaction product of (i) a polyester polyol based on a dimeric acid and an aromatic dicarboxylic acid, and (ii) an isocyanate monomer.

2. The polyurethane adhesive composition of claim 1, wherein the polyurethane adhesive composition is solvent-free.

3. The polyurethane adhesive composition of claim 1, wherein the polyester polyol based on a dimeric acid and an aromatic dicarboxylic acid is prepared from a reactive mixture of at least one dimeric acid, at least one aromatic dicarboxylic acid, and at least one polyol.

4. The polyurethane adhesive composition of claim 3, wherein the weight ratio of the at least one aromatic dicarboxylic acid to the at least one dimeric acid is >0 and <4.2.

5. The polyurethane adhesive composition of claim 3, wherein the at least one dimeric acid is selected from the group consisting of acyclic dimeric acids, cyclic dimeric acids, aromatic dimeric acids, polycyclic dimeric acids, and any combination thereof.

6. The polyurethane adhesive composition of claim 3, wherein the at least one aromatic dicarboxylic acid is selected from the group consisting of phthalic acid, isophthalic acid, terephthalic acid, and any combination thereof.

7. The polyurethane adhesive composition of claim 1, wherein the polyol component comprises from 1% to 50% of the phosphate modified polyol, and from 1% to 99% of the vegetable oil modified polyol, by weight of the polyol component.

8. The polyurethane adhesive composition of claim 1, wherein the isocyanate component and the polyol component have an NCO/OH molar ratio of from 0.9:1 to 1.95:1.

9. An isocyanate agent for use in a polyurethane adhesive composition, comprising an NCO-terminated polyurethane prepolymer that is the reaction product of (i) a polyester polyol based on a dimeric acid and an aromatic dicarboxylic acid, and (ii) an isocyanate monomer.

10. A method of using the polyurethane adhesive composition of claim 1, comprising:
(a) providing the polyurethane adhesive composition of claim 1;
(b) bringing the polyol component and the isocyanate component into contact, to form a curable mixture;
(c) applying the curable mixture to a first substrate to which at least a second substrate is to be bonded;
(d) bringing the second substrate into contact with the first substrate so that at least a portion of the curable mixture is sandwiched between the first substrate and the second substrate; and
(e) curing the curable mixture or allowing it to cure.

11. Use of the polyurethane adhesive composition of claim 1 in a battery pack.
